(19) United States
(12) Patent Application Publication
(10) Pub. No.: US 2006/0270407 A1
(43) Pub. Date: Nov. 30, 2006

(54) Wireless communication system, wireless communication apparatus, wireless base station apparatus, and method for controlling handoffs

(75) Inventor: Hiroyuki Hidaka, Kawasaki-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/441,826

(22) Filed: May 26, 2006

(30) Foreign Application Priority Data
May 27, 2005 (JP) P2005-156113

(51) Int. Cl. H04Q 7/20

(52) U.S. Cl. 455/436; 455/422.1; 455/424

(57) ABSTRACT

A wireless communication system, comprises: a wireless base station apparatus that sends base station information including information on a service that can be provided by a neighbor wireless base station apparatus to a communication area of the wireless base station apparats; and a wireless communication apparatus that receives t base station information, determines whether or not the service that is currently in use is available in a handoff destination wireless base station apparatus by looking up the base station information, and performs a handoff to the handoff destination on wireless base station apparatus when the service that is currently in use is available In the handoff destination wireless base station apparatus.

### BACKGROUND OF THE INVENTION

1. Field of the Invention

The present invention relates a wireless communication system in which wireless communication is established between a wireless communication apparatus and a wireless base station, a wireless communication apparatus, a wireless base station apparatus, and a method for controlling handoffs.

Priority is claimed on Japanese Patent Application No. 2005-156113, filed May 27, 2005, the content of which is incorporated herein by reference.

2. Description of the Related Art

In the wireless communication technologies using wireless communication apparatuses via a base station, the base station sends, as notification information to be sent to all wireless communication apparatuses in the area thereof, information required for reception and transmission of wireless signals, or neighbor base station information required for maintaining a channel, such as handoffs. For example, in the case of the wireless communication technology compliant with the IS95 scheme, neighbor base station information sent by a base station includes various types of information, such as a wireless class (NGHBR_BAND), a frequency (NGHBR_FREQ), information on the operation reference time of base station (NGHBR_PN, NGHBR_TX_OFFSET, . . . ). In response to receiving the base station information, a wireless communication apparatus stores the information, and performs functions, such as handoff for switching between base stations for managing a communication channel using this base station information.

Details of handoffs in accordance with the IS95 scheme are described in many documents, such as Japanese Unexamined Patent Application, First Publication No. 2003-189346.

In wireless communication technologies using wireless communication apparatuses, a new service called “broadcast multicast service (BCMCS)” is proposed in which a plurality of wireless communication apparatuses simultaneously shares a single communication channel for providing an information service of a broadcast type (i.e., broadcast service). This service is capable of stopping provision of information contents when no user is using the service from the viewpoint of an effective utilization of wireless resources, and frees the communication channel used for the BCMCS so that the channel can be used as a general channel.

However, this method is the following shortcoming when a wireless communication apparatus using the BCMCS moves within &a communication area of the wireless base station and perform a handoff to another wireless base station. With the conventional wireless communication technologies, it is possible to the wireless communication channel. However the wireless base station before the handoff cannot tell whether or not a wireless service, such as a broadcast service provided using the wireless channel, is satellite (i.e.. broadcasted) in the wireless base station of the handoff destination. Thus, the service cannot be maintained if the broadcast service is not stared (i.e., broadcasted) in the handoff destination wireless base station.

As a result, since the wireless communication apparatus performs a handoff to a second wireless base station in which the broadcast service is not (i.e., broadcasted), a start request for the service must be issued because the handoff destination wireless base station bas not started (i.e.. broadcasted) the broadcast service. In this case, an interruption of the broadcast service occurs until the start of the service is provided aft tho service start request is issued.

### SUMMARY OF THE INVENTION

The present invention was conceived given the above-described bound, and an object thereof is to provide a wireless communication system, a wireless communication apparatus, a wireless base station apparatus, and a method for controlling handoffs which can reliably handle handoff without causing an interruption of a service.

A fir aspect of the present Invention is a wireless communication system comprising: a wireless base station apparatus that sends base station information including information on a service that can be provided by a neighbor wireless base station apparatus to a communication area of the wireless base station apparatus; and a wireless communication apparatus that receives the base station information, determines whether or not the service that is currently in use is available in a handoff destination wireless base station apparatus by looking up the base station information, and performs a handoff to the handoff destination wireless base station apparatus when the service that is currently in use is available in the handoff destination wireless base station apparats.

In a second aspect of the present invention, in the above-described wireless communication system, the wireless communication apparatus may send to the wireless base station apparatus that receives the base station ion a start request requesting a start of the service that it is currently in use in the handoff destination wireless base station apparatus when the service that it is currently in use is not started in the handoff destination wireless base station p and the handoff destination wireless base station apparatus may start the requested service when it receives the start request of the service.

A third aspect of the present invention is a wireless communication apparatus, comprising: a reception section that receives from a wireless base station apparatus base station information including information on a service that can be provided by a neighbor wireless base station apparatus; and a handoff control station that determines whether or not the service that is currently in use is available in a handoff destination wireless base station apparatus by looking up the based on information received, and performs a handoff to the handoff destination wireless base station apparatus when the service that is currently in use is available in the handoff station wireless base station apparatus.

A fourth aspect of the present invention may further comprises, in the above-described wireless communication apparatus, a transmission section that sends to the wireless base station apparatus that receives the base station i on a start request requesting a start of the service that it is currently in use in the handoff destination wireless base station apparatus when the service that it is currently in use is not started in the handoff destination wireless base station apparatus.

A fifth aspect of the present invention is a wireless base station apparatus, comprising: a base station information notification section that sends base station information including information on a service that is able to be provided by a neighbor wireless base station apparatus to a communication area of the wireless base station apparatus; and a transmission section that, upon receiving a start request requesting a start of a service in a neighbor wireless base station apparatus from a wireless communication apparatus within a communication area of the wireless base station apparatus, sends a service start request so that the requested service is started in the neighbor wireless base station apparatus.

A sixth aspect of the present invention is a method for controlling handoffs , comprising: receiving from a wireless base station apparatus base station information including information on a service that can be provided by a neighbor wireless base station apparatus; determining whether or not the service that is currently in use is available in a handoff destination wireless base station apparatus by looking up the base station information received; and performing a handoff to the handoff destination wireless base station apparatus when the service that is currently in use is available in the handoff destination wireless base station apparatus.

A seventh aspect of the present invention may further comprises, in the above-described method for controlling handoffs, sending to the wireless base station apparatus that receives the base station information a start request requiring a start of the service that it is currently in use in the handoff destination wireless base station apparatus when the service that it is currently in use is not start request in the handoff destination wireless base station apparatus.

According to the present invention, an advantageous effect in that handoffs can be notably handled without causing an interruption of a service is achieved.

### BRIEF DESCRIPTION OF THE DRAWINGS

FIG. 1 is a block diagram showing a configuration of an embodiment of the present invention.

FIG. 2 is a flowchart showing an operation of the wireless communication system shown in FIG. 1.

FIG. 3 is a schematic diagram illustrating a table structure of neighbor base station information.

FIG. 4 is a schematic diagram illustrating a table structure of the neighbor base station information.

FIG. 5 is a schematic diagram illustrating a table structure of the neighbor base station information.

FIG. 6 is a schematic diagram illustrating a table structure of a search list of the neighbor base station information.

FIG. 7 is a schematic diagram illustrating a table structure of information contained i a start request message of a provision service of a neighbor base station.

FIG. 8 is a schematic diagram illustrating a table structure of information contained in a start request message of a provision service of a neighbor base station

FIG. 9 is a schematic diagram illustrating a deployment relationship between base stations.

FIG. 10 is a schematic diagram illustrating a deployment relationship between base stations.

### DETAILED DESCRIPTION OF THE INVENTION

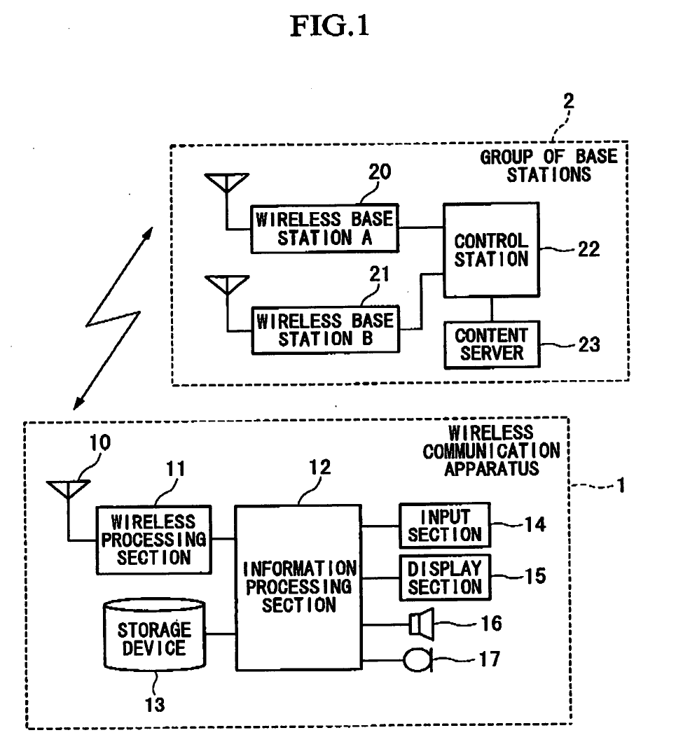

A wireless communication system according to one embodiment of the present invention will now be described with reference to the attached drawings. FIG. I is a block diagram showing a configuration of an embodiment of the present invention. In FIG. 1, reference numeral 1 denotes a wireless communication apparatus for communicating via a radio frequency. Reference numeral 2 denotes a group of base stations that is made up of a plurality of wireless base stations for communicating with the wireless communication apparatus 1 via a radio frequency. Reference numeral 11 denotes a wireless processing section that establishes wireless communication with a wireless base station consisting the group of base stations 2 via an antenna 10. Reference numeral 12 denotes an information processing section that exercises control over operations of tie wireless communication apparatus 1 as well as handling services utilizing the established wireless communication reference numeral 13 denotes a storage device that stores base station information, such as information for identifying a service currently being used, or notification information about neighbor base station information sent by the wireless base station Reference numeral 14 denotes an input section made up of a key panel on which various keys including a dial key, function keys, or the like, are arranged. Reference numeral 15 denotes a display section male up of a liquid crystal display or the like. Reference numeral 16 denotes a speaker and whence numeral 17 denotes a microphone. Reference numerals 20 and 21 (hereinafter, A20 and B21 are also used) denote wireless base sons that construct communication areas and communicate with the wireless communication apparatus 1. Reference numeral 22 denotes a control station that controls the wireless base station A20 and the wireless base station B21 and allows information transmission between the wireless base stations A20 and B21. Reference numeral 23 denotes a content server that stores service contents provided to the wireless communication apparatus 1. Although only two wireless base stations, namely, the wireless base station A20 and the wireless base station B21 are shown in FIG. 1, wireless base stations B-G that are present at least in a neighborhood of the wireless base station A20 may be connected to the control station 22, as shown in FIG. 9. The group of base stations 2 is a logical name. Suppose that the wireless base station with which the wireless communication apparatus 1 i curly communicating is the wireless base station A, the wireless base station A and neighbor base stations of the wireless base station A, namely the neighbor base stations B-Kg, are included in the group of base stations 2.

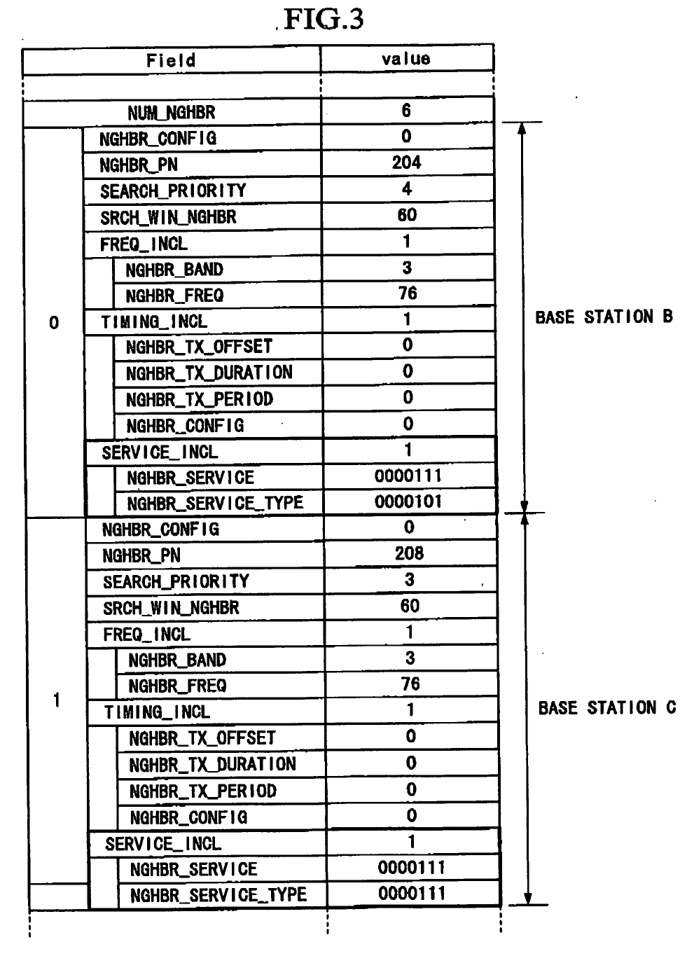

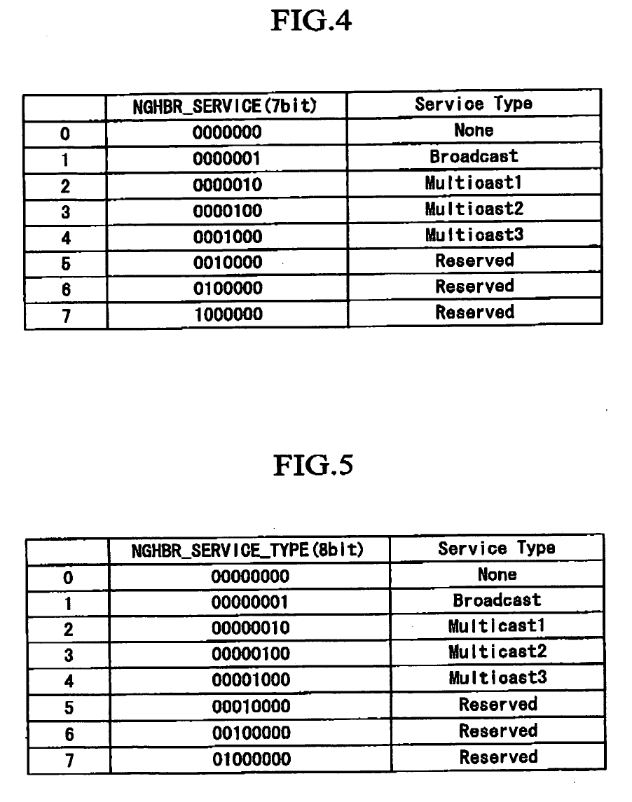

Thereinafter, structure of neighbor base station information, a search list of neighbor base stations, and a service station request message requesting a service the neighbor base station can provide will be described with reference to FIGS. 3 to B. First, with reference to FIGS. 3 to 5, neighbor base station information Included In notification information sent by the wireless base station to the wireless communication apparatus 1 that is present within its communication area will be described. FIG. 3 is a diagram illustrating information elements of babe station information on the wireless base stations B and C that are present in the neighborhood of the wireless base station A20. Although only the wireless base stations B and C are shown in FIG. 3, the neighbor base station information may further include base station information on the wireless base stations D-Kg. The neighbor base station information according to the present invention is different from neighbor base station information compliant with the IS95 scheme in that the neighbor base station information according to the present invention further has NGHBRE_SERVICE data that indicates a type of a service a wireless base station can provide and NGHBRE_SERVICE_TYPE data that indicates the stays of that service. FIG. 4 is a diagram illustrating a bit structure of the NGHBRE_SERVICE data shown in FIG. 3. The NGHBRE_SERVICE is a 7-bit data, and the type of the service can be determined based on the bit position. FIG. 5 is a diagram illustrating a bit 8 of the NGHBRE_SERVICE_TYPE data shown in FIG. 3. The NGHBRE_SERVICE_TYPE is an 8-bit data, and the status of the service can be determined based on the bit position.

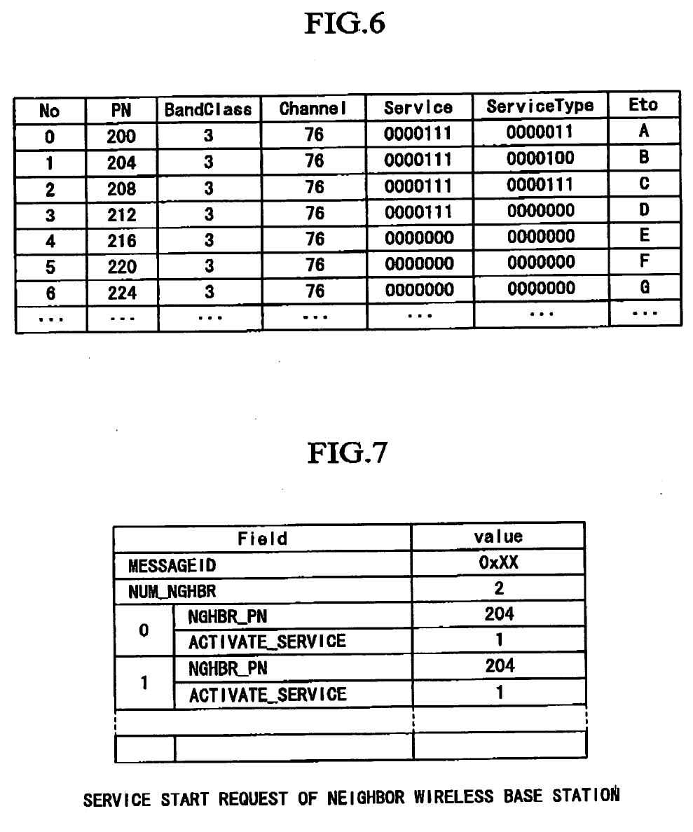

Next, a search list of neighbor base stations will be described with reference to FIG. 6. This list is generated within the wireless communication apparatus 1 based on neighbor base station information included in notification information sent by a wireless base station with which the wireless communication apparatus 1 is currently communication (i.e., being connecting). The list is then stored in the storage device 13. FIG. 6 is a digram illustrating a structure of the search list of neighbor base stations generated within the wireless communication apparatus 1. As shown i FIG. 6, in the search list of neighbor base stations, based on the neighbor base station information received by the wireless communication apparatus 1, information on the wireless base stations B-Kg (corresponding to Nos. 1-6) that are located in the neighborhood of the wireless base station A20 with which the wireless communication I is currently communicating is stored. FIG. 6, the “service” data is data that can be used for determining the type of the service based on its bit position, and the “service_type” data is data that can be used for determining the status of the service based on its bit position.

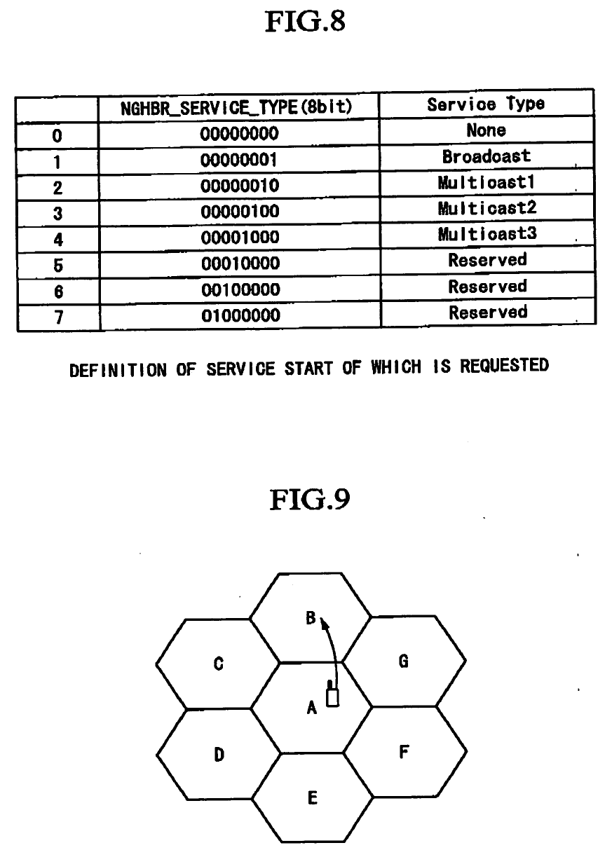

Next, with reference to FIGS. 7 and 8, information included in the service start request message that requests, to a neighbor wireless base station of the wireless base station with which the wireless communication apparat 1 is currently communicating, a start of a service currently being used will be described. FIG. 7 is a diagram illustrating a structure of the information included in the service start request message to be sent to the wireless base station currrently in communication, requiring a neighbor wireless base station to start a service. The information includes a type of a service the start of which is requested (ACTIVATE_SERVICE) for each neighbor wireless base station. FIG. 8 is a data We defining a type of service the start of which is requested. The service type (ACTIVATE_SERVICE) is an 8-bit data, and the service type can be determined based on the bit position.

In the following description, it is assumed that the wireless communication apparatus 1 is located within the communication area of the wireless base station A20 in the environment shown in FIG. 9. Furthermore, it is assumed that the wireless communication apparatus 1 uses a broadcast service provided by the wireless base station A20. In this case, the value of a service information flag InuseServ stored within the wireless communication apparatus 1 is set to “00000001” (indicating a broadcast service).

Hereinafter, basic operations of the wireless communication apparatus 1 will be described briefly. The wireless communication apparatus 1 generates a neighbor base station search list Neighbor from the neighbor base station information included in notification information (including service information) sent from the wireless base station, and stores it in the storage device 13. Furthermore, the wireless communication apparatus 1 stores the service that it is currently in use in a service in ion flag InuseServ. The wirless communication apparatus 1 determines wireless base stations that can provide the service using the following equations (1), (2), and (3) every time the radio wave statuses of the neighbor wireless base stations are measured The wireless communication apparatus 1 measures a radio field intensity only for the wireless base stations that can provide the sere.

The wireless communication apparatus 1 determines whether or not the service is available using the equation (1) based on the service information flag InuseServ of the service that it is currently in use in the group of the wireless base stations located in the neighborhood of the wireless base station currently communicating.
(InuseServ&Neighbor[i].service)=InuseServ . . . . (1)

where “&” represents an AND operation of bits, [i] represents an ith wireless base station, Neighbor[i].service repress the value of the “service” data shown in FIG. 6 of the ith wireless base station. Accordingly, when the equation (1) is evaluated as “true” it can be confirmed that the same service as the service currently being provided is available.

In contrast, when the equation (2) is evaluated as “true,” a jth wireless base station cannot provide the same service as the service currently used by the wireless communication apparatus 1.
(InuseServ&Neighbor[i].service)≠InuseServ . . . . (2)

The wireless communication apparatus 1 can narrow down candidate base stations fir a handoff based on the evaluation equations (1) and (2).

Furthermore, when the wireless communication apparatus 1 decides &a the radio field intensity from the neighbor wireless base station B21 becomes stronger than that of the wireless base station A20 currently communicating upon an occurrence of the handoff, the wireless communication apparatus 1 determines whether or not the same service as the service that it is currently in use has been stated (broadcasted) by the handoff destination wireless base station 121 using equation (3).
(InuseServ&Neighbor[i].serviceType)=InuseServ . . . . (3)

where Neighbor[i].serviceType represents the value of the “service_type” data shown in FIG. 6. When his equation is evaluated as rue,” it can be confined that the same service as the service currently used by the wireless communication apparatus 1 has also been stared (i.e., broadcasted) by the wireless base station B21, therefore, an interruption of the service will not occur by the handoff, and the wireless communication apparatus it can start a off operating to the wireless base station B21. In contrast, when this equation is evaluated as “false,” it can be confirmed that the service is being stopped in the wireless base station B21. Thus the wireless communication apparatus 1 sends a service start request for the wireless base station B21 to the wireless base station A20 that is currently in communication (i.e., that received the neighbor base station information). The wireless base station A20 sends a service start request for the wireless base station B21 to the control station 22, the wireless communication apparatus 1 confirms that the desired service has been started in the wireless base station B21 based on notification information sent by the wireless base station A20, and the wireless communication apparatus 1 starts a handoff to one wireless base station B21.

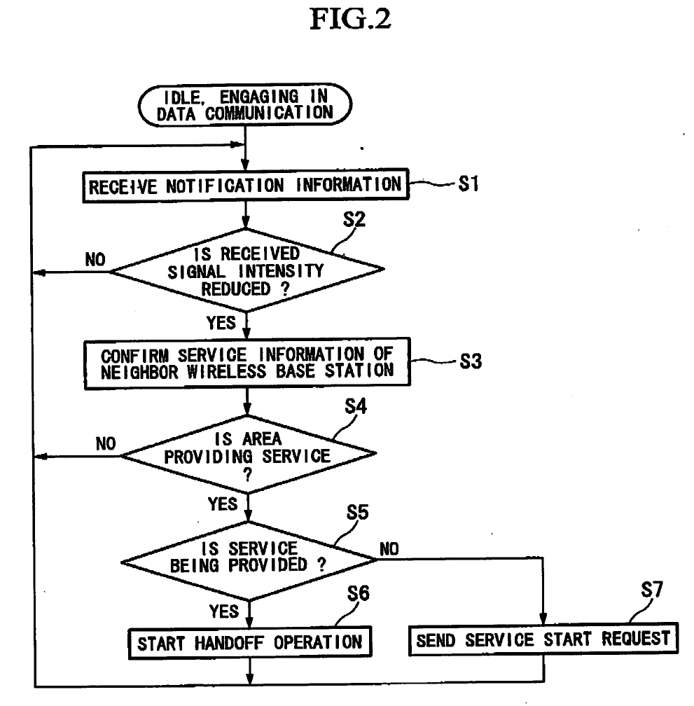

Next, the operations of the wireless communication apparatus 1 shown in FIG. 1 will be described with reference to FIG. 2.

First the wireless processing section 11 receives the neighbor base station information (shown in FIG. 3) included in notification information that is sent by the wireless base A20 (step S1). the wireless communication apparatus 1 generates a neighbor base station search list (shown in FIG. 6) from the neighbor base station information, and stores the neighbor base station search list in the stop device 13. Since the neighbor base station information is sent in a certain time interval, the information processing section 12 in the neighbor base station sea list every time it receives the information. Thereafter, the wireless processing section 11 measures the signal intensity of the wireless communication base station A20 with which the wireless communication apparatus is currently communicating (step S2), and determines whether or not the signal intensity of the received signal is reduced. When the signal intensity is not reduced below a certain signal intensity in the evaluation, it is determined that no handoff is necessary and the flows return to step S1 in-which the operation is continued. In contrast, when the intensity of a received signal is reduced below the certain signal intensity, the information processing section 12 determines that a handoff is required. The information processing section 12 looks up the neighbor base station search list stored in the storage device 13 (step S3), and creates a neighbor base station list of the neighbor base stations that can provide the service that is currently used by the wireless communication apparatus 1 (step S4). Next, the wireless communication apparatus 1 measures signal intensities of the neighbor base stations registered in tie neighbor base station list, and selects a neighbor base station that can be a handoff destination. As a result, a neighbor base station t can be a handoff candidate (the wireless base station B in this example) is selected. It should be noted that if them is no wireless base station to be a handoff candidate (i.e., there is no base station that provides the same service), the communicating is continued without executing a handoff.

In contrast, when a wireless base station to be a handoff candidate is found (i.e., there is a base station that provides the same service), it is determined whether or not the service currently used by the wireless base station has been stated (i.e. now being broadcasted) by that wireless base station (stop S5). W hen se vice has b started (i.e., now being broadcasted) the information processing section 12 issues an l on to start a handoff operation to the wireless processing section 11. In response, the wireless processing section 11 performs a handoff (step S6). In contrast, when the service can be provided (i.e., started) but the service is not currently started (i.e.. the service is being stopped), the information posing section 12 sends a service start request to the wireless base station A20 via the wireless proceed section 11 (step S7). Once the wireless base station A20 receives this service start request, it instructs a start of the service to the wireless base station B21 via the control station 22. The wireless base station B21 receives the instruction from the control station 22, and stars the vision of the request service.

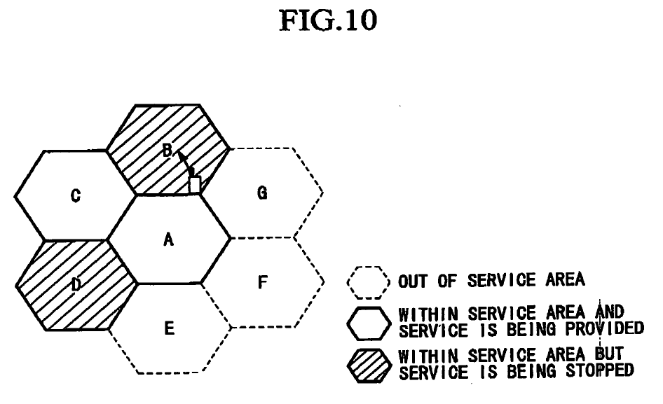

The operations shown in FIG. 2 will be described using specific examples. The wireless communication apparatus 1 moves around, and accordingly the intensity of signal received from the wireless base station A20 is reduced while the intensity of the signal from the wireless base station B21 is increased. The wireless communication apparatus 1 checks the provision stats of the service by looking up the neighbor base station search list stored in the storage device 13 (shown FIG. 6) in anticipation of a handoff to the wireless base station B21. When the service information of the wireless base station B is as the data No. 1 shown in FIG. 6, it can be confirmed that the broadcast service can be provided (i.e., started) but the service is currently stopped in the wireless base station B based On the service” of “0000111” and the “service_Type” of “0000100” (see FIG. 10). The wireless communication apparatus 1 sends the service start request message shown in FIGS. 7 and 8 to the wireless base station A20 for making the broadcast service active (i.e.. started) in the wireless base station B. The wireless base station A20 mutes the service start request message to {he wireless base station B21 via the control station 22. In response, the wireless base station B21 starts the broadcast service. Once the wireless communication apparatus 1 receives a notification information sent from the wireless base station A20 and confirms that the broadcast service has beg started in the wireless base station B21, it starts a handoff operation from the wireless base station A20 to the wireless base station B21.

As dubbed previously, information on a service that can be provided by neighbor wireless base stations and status information on the service indicating whether the service is currently being shed (i.e., broadcasted) or stopped are included in the notification information sent to all wireless commuication apparatuses in the area thereof by a wireless base station. Upon a Payoff, the wireless communication apparatus 1 looks up the service information rent by the wireless base station and the status information of that service, and it performs a handoff operation only when the service currently being used is available and has been star (i.e., now being broadcasted) in the handoff destination wireless base station. By this configuration, it becomes possible to reliably perform a handoff without causing an interruption of a service. Furthermore, when the service currently being provided is started in a handoff destination wireless base station, a start request requesting a start of the same service as he service currently being used is sent to the handoff destination wireless base station. Thus, even when the handoff destination wireless base station steps the service at pet, it is possible to reliably perform a handoff without disrupting the use of the service.

It Would be noted that the wireless communication apparatus according to the present invention may include a mobile telephone terminal employing mobile communication, a personal digital assistant (DA), a mobile terminal, a car-navigation apparatus, or the like, equipped with a mobile communication feature.

It should be noted that program(s) for implementing the processing section shown in FIG. 1 may be stored in a computer-readable storage medium, and the programs may be loaded to and executed by a computer for performing handoff operations. As used herein, the term “computer system” is not limited to a computer, but includes an operating system and hardware such as a neighbor device. In addition, term “the computer-readable storage medium” refers to storage, such as a removable medium (e.g., a flexible disk, a magneto-optical disk, ROM, a CD-ROM) , or a storage device, such as a bard disk, which is installed into a computer system. Furthermore, the term ,“computer-readable storage medium” includes a medium which stores programs during a certain period of time, such as a volatile memory in a computer system which is capable of being a server or a client when a program is transmitted via a communication line, e.g., a network, such as the Internet, or a telephone line.

Furthermore, the above described programs may be transmitted from a computer system in which the programs are stored in a storage device or the like to another computer s via a transmission medium or carrier waves in a transmission medium. The term “transmission medium” on which the programs are transmitted is a medium that is capable of transmitting information, e.g., a network (communication network), such as the Intern or a communication channel (communication line), such as a telephone line, or the like. In addition, the program describe above may execute only a part of the processes described above. Furthermore, the program may be executed in combination with another program that has been stored in a computer system. Such a program is generally referred to as a difference file (difference program).

While preferred embodiments of the invention have been described and illustrated above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claim.

What is claimed is:

1. A wireless communication system, comprising:
a wireless base station apparatus that sends base station information including information on a service that can be provided by a neighbor wireless base station apparatus to a communication area of the wireless base station apparatus; and
a wireless communication apparatus that receives the base station information, determines whether or not the service that is currently in use is available in a handoff destination wireless base station a by looking up the base station information and performs a handoff to the handoff destination wireless base station apparatus when the service that is currently in use is available in the handoff destination wireless base station apparatus.

2. The wireless communication system according to claim 1, wherein the wireless communication apparatus sends to the wireless base station apparatus that receives the base station information a start request requesting a start of the service that it is currently in use in the handoff destination wireless base station apparatus when the sBe that it is currently in use is not started in the handoff designation wireless base station apparatus and
the handoff destination wireless base station apparatus start the requested service when it receives the start request of the service.

3. A wireless communication apparatus, comprising:
a reception section that receives from a wireless base station apparatus base station information including information on a service that can be provided by a neighbor wireless base station apparatus; and
a handoff control section that determines whether or not the service that is currently in use is available in a handoff destination wireless base station apparatus by looking up the base station information received and performing a handoff to the handoff destination wireless base station apparatus when the service that is currently in use is available in the handoff destination wireless base station apparatus.

4. The wireless communication apparatus according to claim 3, further comprising a transmission section that sends to the wireless base station apparatis that receives the base station information a start request requesting a start of the service that it is gently in use in the handoff destination wireless base station apparatus when the service that it is currently in use is not started in the handoff destination wireless base station apparatus.

5. A wireless base station apparatus, comprising:
a base station information notification section that sends base station information including information on a service that is able to be p by a neighbor wireless base station apparatus to a communication area of the wireless base station apparatus; and
a transmission section that, upon receiving a start request requesting a start of a service in a neighbor Wireless base station apparatus from a wireless communication apparatus within a communication area of the wireless base station apparatus, s a service start request so that the requested service is started in the neighbor wireless base station apparatus.

6. A method for controlling handoffs, comprising:
receiving from a wireless base station apparatus base station information including information on a service that can be provided by a neighbor wireless base station a-s;
determining whether or not the service that is fully in use is available in a handoff destination wireless base station apparatus by looking up the base station information received; and
performing a handoff to the handoff destination wireless base station apparatus when the service that is currently in use is available in the handoff destination wireless base station apparatus.

7. The method for controlling the handoffs according to claim 6, neither comprising sending to the wireless base station apparatus that receives the base station information a start request requesting a start of the service that it is currently in use in the handoff destination wireless base station apparatus when the service apparatus it is currently in use is not started in the handoff destination wireless base station apparatus.
